(19) United States
(12) Patent Application Publication
(10) Pub. No.: US 2006/0003086 A1
(43) Pub. Date: Jan. 5, 2006

(54) Method for manufacturing plasma display panel

(75) Inventor: Michihiko Takase, Nara (JP)

Correspondence Address: WENDEROTH, LIND & PONACK, L.L.P., 2033 K STREET N. W., SUITE 800, WASHINGTON, DC, 20006-1021, US

(73) Assignee: Matsushita Electric Industrial Co., Ltd., Osaka (JP)

(21) Appl. No.: 10/532,672

(22) PCT Filed: Jul. 14, 2004
(86) PCT No.: PCT/JP04/10365

§ 371 Date: Apr. 26, 2005

(30) Foreign Application Priority Data
Jul. 15, 2003 (JP) 2003-197158

(51) Int. Cl. H01J 9/00; H01J 9/24; B05D 5/06; B05D 5/12

(52) U.S. Cl. 427/64; 445/24

(57) ABSTRACT

A method of depositing a high quality metal oxide film onto a substrate of a plasma display panel is provided. At a process for forming protective layer (8) of MgO film which is a metal oxide film, the film is formed within a range of 1×10⁻¹ Pa to 1×10⁻² Pa in a degree of vacuum in evaporation room (21) which is a deposition room, so that a depositing rate and film quality improve in forming protective layer (8). As a result, a plasma display panel which can display high quality images can be manufactured.

### TECHNICAL FIELD

The present invention relates to a method for manufacturing a plasma display panel (PDP) and more particularly to forming a film on the PDP which is known as a display apparatus characterized by its thinness, lightness and large display.

### BACKGROUND ART

In a plasma display panel (hereinafter referred to as a “PDP”), ultraviolet rays, which is generated by discharging gas, excite phosphor to emit light for an image display.

The plasma display panels are classified into two driving systems, i.e. an AC type and a DC type, and classified into two electric discharge systems, i.e. a surface discharge type and an opposed discharge type. The AC and surface discharge type PDP having a three electrodes structure is becoming a mainstream in the PDPs because of its high resolution, large screen and easiness of manufacturing. The AC and surface discharge type PDP is formed of a front substrate and a rear substrate. The front substrate includes a display electrode, which consists of a scan electrode and a sustain electrode, on a substrate such as glass, a dielectric layer covering it and a protective layer further covering it. On the other hand, the rear substrate includes a plurality of address electrodes, a dielectric layer covering it, a barrier rib on the dielectric layer, and a phosphor layer formed on the dielectric layer and sides of the barrier rib. The front substrate and the rear substrate confront each other in such a manner that the display electrode crosses over the address electrode at right angles, so that a discharge cell is formed at an intersection between the display electrode and the address electrode.

Compared with a liquid crystal panel, the PDP has the features, namely, a fast motion display, a wide view angle, easiness of manufacturing a large panel and high quality because of a self luminous type. As a result, recently, the PDP has drawn attention among flat display panels and has various uses (e.g., a display apparatus at a place where many people gather or a display apparatus for enjoying a large screen image at home).

As discussed above, on the glass substrate of the front substrate which works as a face for displaying an image, the electrodes are formed, and the dielectric layer covering them are formed. Furthermore, a magnesium oxide (MgO) film of a metal oxide film as the protective layer for covering the dielectric layer is formed. As a method for forming the protective layer made of the MgO film, an electron beam evaporation method, whose depositing rate is fast and which forms comparatively high quality MgO film, is generally used. For example, the method is disclosed on pp. 598-600 of “2001 FPD technology corpus” published by Electronic Journal Inc in Oct. 25, 2000.

However, when the magnesium oxide (MgO) film of the metal oxide film is formed, physical properties of the film sometimes change by oxygen deficiency or contamination of impurities in its deposition process.

Therefore, an atmosphere of a deposition space is controlled by introducing gas into the deposition space in the deposition process for stabilizing the physical properties of the film. However, the physical properties change depending on a state where the gas is introduced into the deposition room, so that the state of introducing gas is required to be appropriately controlled for stabilizing the physical properties of the film.

The present invention is directed to solve the problems discussed above, and therefore, it is an object to form a metal oxide film such as a high quality MgO film onto a substrate of a PDP.

### SUMMARY OF THE INVENTION

The present invention is directed to solve the problems discussed above, and aims to provide a method for manufacturing a PDP including a process for forming a metal oxide film onto a substrate of the PDP, and the method provides a degree of vacuum in a deposition room ranges from 1×10⁻¹ Pa to 1×10⁻² Pa in a deposition process of the metal oxide film. According to the manufacturing method mentioned above, when the metal oxide film is formed onto the substrate of the PDP, the metal oxide film having high quality physical properties can be formed.

### BRIEF DESCRIPTION OF THE DRAWINGS

FIG. 1 is a sectional perspective view showing a schematic structure of a plasma display panel in accordance with an exemplary embodiment of the present invention.

FIG. 2 is a sectional view showing a schematic structure of a deposition apparatus in accordance with the exemplary embodiment of the present invention.

### DETAILED DESCRIPTION OF THE PREFERRED EMBODIMENT

A method for manufacturing a PDP in accordance with the exemplary embodiment of the present invention is demonstrated hereinafter with reference to the accompanying drawings.

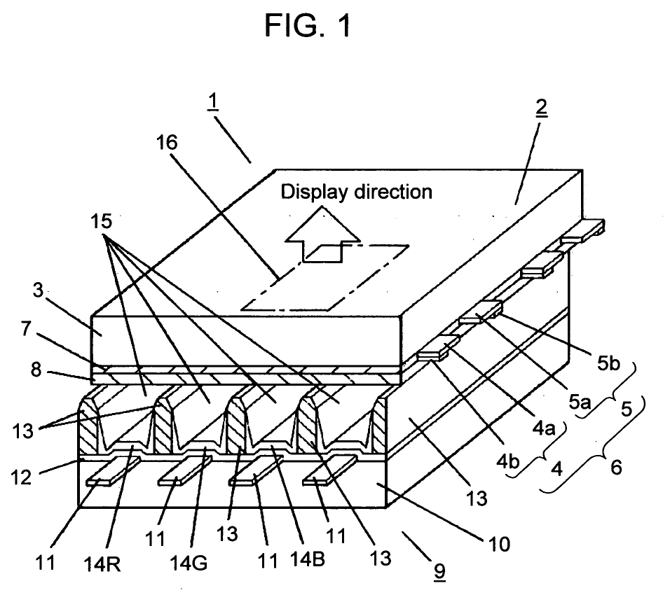

First, an example of a structure of the PDP is described. FIG. 1 is a sectional perspective view showing a schematic structure of the PDP manufactured by the manufacturing method of the PDP in accordance with an exemplary embodiment of the present invention.

Front substrate 2 of PDP 1 includes display electrode 6, which consists of scan electrode 4 and sustain electrode 5, formed on transparent and insulating substrate 3 such as glass, dielectric layer 7 covering display electrode 6, and protective layer 8 made of MgO or the like covering dielectric layer 7. In order to decrease electric resistance, scan electrode 4 is formed by laminating bus electrode 4b, which is made of a metal material such as Ag, on transparent electrode 4a. Similarly, sustain electrode 5 is formed by laminating bus electrode 5b, which is made of a metal material such as Ag, on transparent electrode 5a.

Rear substrate 9 includes address electrode 11 formed on insulating substrate 10 such as glass, dielectric layer 12 covering address electrode 11, barrier rib 13 positioned on dielectric layer 12 between adjacent address electrodes 11, and phosphor layers 14R, 14G and 14B between barrier ribs 13.

Front substrate 2 and rear substrate 9 confront each other in such a manner that display electrode 6 and address electrode 11 cross each other at right angles across barrier rib 13, so that peripheries outside image display areas are sealed by sealing members. For example, discharge gas such as Ne—Xe of 5% is sealed in discharge space 15 formed between front substrate 2 and rear substrate 9 with 66.5 kPa (500 Torr) of pressure. An intersection between display electrode 6 and address electrode 11 at discharge space 15 works as discharge cell 16 (unit emitting domain).

Next, a method for manufacturing PDP 1 is demonstrated hereinafter with reference to FIG. 1.

For forming front substrate 2, scan electrode 4 and sustain electrode 5 are formed on substrate 3. Specifically, on substrate 3, a film made of ITO or the like is formed by a deposition process such as evaporation or sputtering. Then, patterning is performed using a photolithography method or the like, so that transparent electrodes 4a and 5a are formed. Furthermore, from above, a film made of Ag or the like is formed by a deposition process such as evaporation or sputtering. Then, patterning is performed using a photolithography method or the like, so that bus electrodes 4b and 5b are formed. Using the method discussed above, display electrode 6 which consists of scan electrode 4 and sustain electrode 5 can be obtained.

Then, display electrode 6, which is formed mentioned above, is covered with dielectric layer 7. Dielectric layer 7 is, for example, formed by screen-printing a paste containing lead-base glass material and firing. For example, a mixture of PbO (70 wt %), B₂O₃ (15 wt %), SiO₂ (10 wt %), Al₂O₃ (5 wt %) and organic binder (e.g. dissolved material made by dissolving ethylcellulose of 10% in α-terpineol) is used as the paste containing lead-base glass material mentioned above. Dielectric layer 7, which is formed mentioned above, is covered with the metal oxide film, e.g. protective layer 8 made of MgO or the like.

On the other hand, for forming rear substrate 9, address electrode 11 is formed on substrate 10. Specifically, on substrate 10, a film made of Ag material or the like is formed by a deposition process such as evaporation or sputtering. Then, patterning is performed using a photolithography method or the like, so that address electrode 11 is formed. Furthermore, address electrode 11 is covered with dielectric layer 12, so that barrier rib 13 is formed.

After that, phosphor layers 14R, 14G and 14B, which are respectively made of phosphor particles of red (R), green (G) and blue (B), each is formed at a groove between barrier ribs 13. Phosphor ink in paste form, which is formed of the phosphor particles corresponding to each color and organic binder, is applied and fired for burning the organic binder. As a result, the phosphor particles are bonded, so that phosphor layers 14R, 14G and 14B are formed.

Front substrate 2 and rear substrate 9, both of which are formed discussed above, are put together in such a manner that display electrode 6 of front substrate 2 crosses over address electrode 11 of rear substrate 9 at right angles. Sealing members made of sealing glass are inserted into peripheries and fired so as to form a hermetic seal layer (not shown) for sealing. After that, discharge space 15 is exhausted to be a high vacuum, then filled with discharge gas (e.g., He—Xe base, Ne—Xe base inert gas) at certain pressure and sealed, so that PDP 1 is produced.

In the manufacturing process of PDP 1 discussed above, an example of the process for depositing protective layer 8 is demonstrated hereinafter with reference to the accompanying drawings.

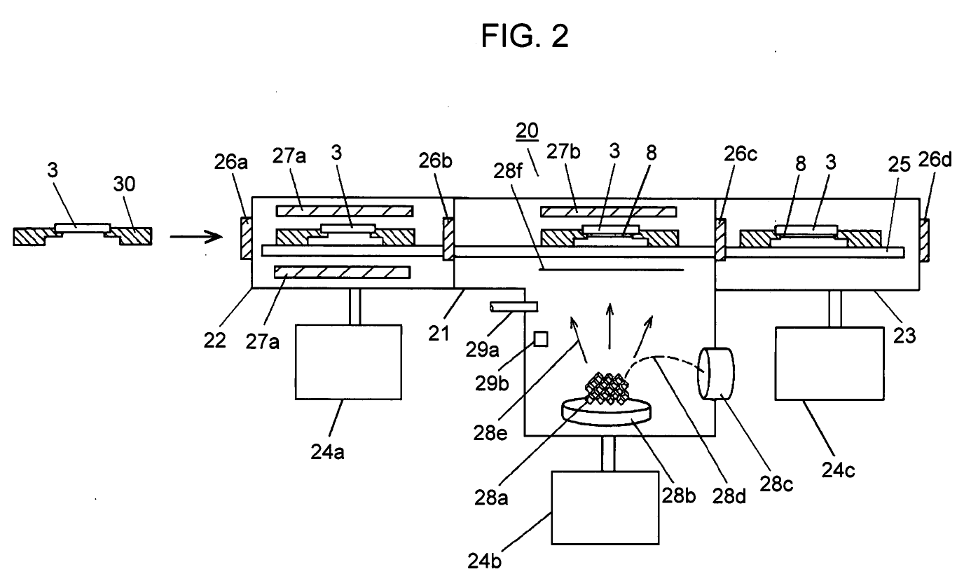

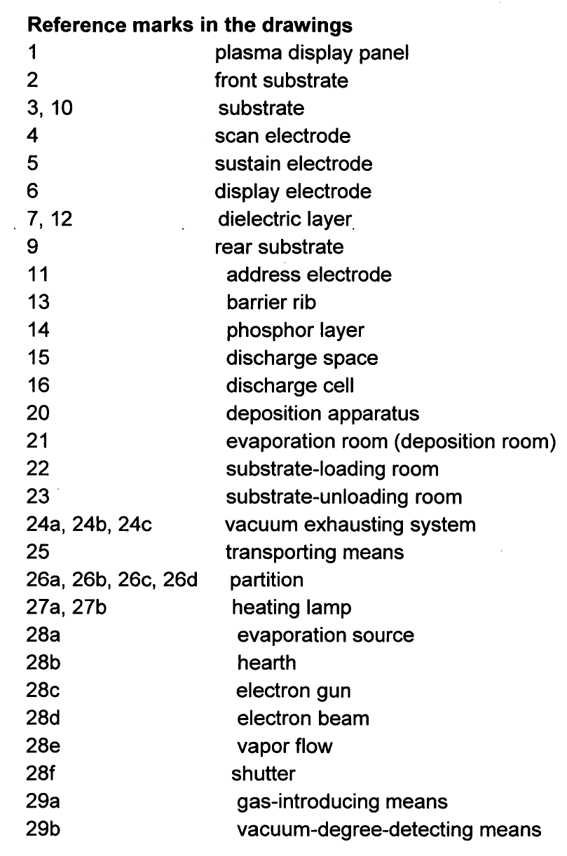

First, an example of a deposition apparatus is described hereinafter. FIG. 2 is a sectional view showing a schematic structure of deposition apparatus 20 for forming protective layer 8.

Deposition apparatus 20 includes evaporation room 21, substrate-loading room 22 and substrate-unloading room 23. Evaporation room 21 is a deposition room for forming protective layer 8 of MgO film onto substrate 3 of the PDP by evaporating MgO. Substrate-loading room 22 is a room for pre-heating substrate 3 and pre-exhausting before substrate 3 is conveyed into evaporation room 21. Substrate-unloading room 23 is a room for cooling substrate 3 after evaporation in evaporation room 21.

Substrate-loading room 22, evaporation room 21 and substrate-unloading room 23 have hermetic structures to make their inside vacuum atmospheres, and have vacuum exhausting systems 24a, 24b and 24c separately.

Transporting means 25 such as transporting roller, wire or chain is disposed through substrate-loading room 22, evaporation room 21 and substrate-unloading room 23. Openable and closable partitions 26a, 26b, 26c and 26d are respectively disposed for partitioning between the ambient air and substrate-loading room 22, between substrate-loading room 22 and evaporation room 21, between evaporation room 21 and substrate-unloading room 23, and between substrate-unloading room 23 and the ambient air. Fluctuations of vacuum degrees of substrate-loading room 22, evaporation room 21 and substrate-unloading room 23 are minimized by interlocking driving of transporting means 25 with opening and closing of partitions 26a, 26b, 26c and 26d. From the outside of the deposition apparatus, substrate 3 passes through substrate-loading room 22, evaporation room 21 and substrate-unloading room 23 in this order, and prescribed processes are performed at respective rooms. After that, substrate 3 can be unloaded out of deposition apparatus 20. Therefore, MgO can be sequentially deposited onto a plurality of substrates 3.

Heating lamps 27a and 27b for heating substrate 3 are respectively disposed at substrate-loading room 22 and evaporation room 21. Substrate 3 is generally conveyed in a state where substrate 3 is held by substrate holding jig 30.

Next, evaporation room 21 as the deposition room is described hereinafter. Hearth 28b containing MgO grains as evaporation source 28a, electron gun 28c and deflection magnet (not shown) for applying a magnetic field are disposed in evaporation room 21. Electron beam 28d irradiated from electron gun 28c is deflected by the magnetic field generated from the deflection magnet and irradiated to evaporation source 28a, so that vapor flow 28e of MgO as evaporation source 28a is generated. Generated vapor flows 28e are deposited onto a surface of substrate 3 held by substrate holding jig 30, so that protective layer 8 of MgO is formed.

Inventors of the present invention have confirmed by examinations that physical properties of the MgO film as protective layer 8 have changed by oxygen deficiency or contamination of impurities in the deposition process. For example, when oxygen is lacked or impurities such as C or H are mingled in MgO, bonding between Mg atom and O atom is disordered. In this case, it is thought that dangling bonds which are not related to bonding are generated, so that a state of secondary electron emission changes.

Therefore, for stabilizing the physical properties of the MgO film and securing characteristics of protective layer 8, the atmosphere is controlled by introducing various gases into the deposition room in the deposition process to control amount of the dangling bonds in the MgO film. In this case, an oxygen gas is suitable as the various gases for preventing oxygen deficiency and restraining the amount of the dangling bonds. On the other hand, a gas selected from the group consisting of water, hydrogen, carbon monoxide and carbon dioxide is suitable for mingling impurities such as C or H positively into the film and increasing the amount of the dangling bonds.

However, inventors of the present invention have confirmed by examinations that if the vacuum degree in the deposition space changes in a case where the atmosphere of evaporation room 21 is controlled for depositing, a depositing rate and film quality are adversely affected.

In a word, inventors of the present invention have confirmed by examinations that it is important for forming a high quality metal oxide film to deposit while the vacuum degree in evaporation room 21 as the deposition room, especially at the deposition space, is kept within a certain range of 1×10⁻¹ Pa to 1×10⁻² Pa. Here, the deposition space denotes a space between hearth 28b and substrate 3 in evaporation room 21, and a vacuum degree denotes a degree of vacuum at the deposition space in the following descriptions.

According to the manufacturing method of the PDP in the present embodiment, the metal oxide film such as MgO is deposited in such a manner that the vacuum degree at the deposition space is controlled within a range of 1×10⁻¹ Pa to 1×10⁻² Pa. Using the method mentioned above, in forming protective layer 8 of MgO film, the depositing rate and film quality improve, whereby a high quality MgO film can be formed.

To perform controlling the vacuum degree discussed above, at evaporation room 21 as the deposition room, at least one gas-introducing means 29a, which can introduce various gases for controlling the environment in evaporation room 21, is installed. For example, oxygen gas, or at least one gas selected from the group consisting of water, hydrogen, carbon monoxide and carbon dioxide, or inert gas such as argon, nitrogen, helium can be introduced individually or together by gas-introducing means 29a.

In addition, evaporation room 21 includes vacuum-degree-detecting means 29b and a controlling means (not shown). Vacuum-degree-detecting means 29b detects a vacuum degree in evaporation room 21. The controlling means controls the amount of introducing gas from gas-introducing means 29a and the amount of exhausting gas by vacuum exhausting system 24b based on information of the vacuum degree from vacuum-degree-detecting means 29b in such a manner that the vacuum degree in evaporation room 21 becomes within a certain range. Using the structure discussed above, in an equilibrium state between the amount of introducing gas from gas-introducing means 29a and the amount of exhausting gas by vacuum exhausting system 24b, a state where the vacuum degree ranges within 1×10⁻¹ Pa to 1×10⁻² Pa at the deposition space in evaporation room 21 as the deposition room can be obtained. In this state, the metal oxide film such as MgO can be evaporated.

Specifically, when at least one gas selected from the group consisting of water, hydrogen, carbon monoxide and carbon dioxide is introduced in a given quantity for obtaining MgO film having prescribed physical properties, with the gas introducing, oxygen or gas containing oxygen is introduced into the deposition space. At that time, the amount of introducing gas is controlled and equilibrated with the amount of exhausting gas, so that the vacuum degree can be controlled within a certain range.

In addition, when oxygen or gas containing oxygen is introduced in a given quantity for obtaining MgO film having prescribed physical properties, with the gas introducing, at least one gas selected from the group consisting of water, hydrogen, carbon monoxide and carbon dioxide is introduced into the deposition space. At that time, the amount of introducing gas is controlled and equilibrated with the amount of exhausting gas, so that the vacuum degree can be controlled within a certain range.

Furthermore, when oxygen or gas containing oxygen and at least one gas selected from the group consisting of water, hydrogen, carbon monoxide and carbon dioxide is introduced in a given quantity for obtaining MgO film having prescribed physical properties, inert gas such as Ar, nitrogen, helium is introduced into the deposition space. At that time, the amount of introducing gas is controlled and equilibrated with the amount of exhausting gas, so that the vacuum degree can be controlled within a certain range. Because inert gas does not act chemically on the MgO film, the vacuum degree can be controlled without adversely affecting physical properties of the MgO film.

Besides, at least one of inert gas and carbon dioxide, and oxygen gas may be introduced into the deposition space. At that time, the amount of introducing gas is controlled and equilibrated with the amount of exhausting gas, so that the vacuum degree may be controlled within a certain range.

Next, a flow of deposition is described hereinafter. In evaporation room 21 as the deposition room, substrate 3 is heated by heating lamp 27b and kept at a certain temperature. The temperature is set approximately 100° C. to 400° C. in such a manner that display electrode 6 and dielectric layer 7, both of which have been already formed on substrate 3, do not deteriorate by the heat. Then, with shutter 28f closed, electron beam 28d is irradiated from electron gun 28c to evaporation source 28a for pre-heating, so that impure gas is removed. After that, gas is introduced from gas-introducing means 29a. For example, oxygen gas, or at least one gas selected from the group consisting of water, hydrogen, carbon monoxide and carbon dioxide, or inert gas such as argon can be used as the gas in that case.

The vacuum degree is controlled within 1×10⁻¹ Pa to 1×10⁻² Pa by keeping the amount of introducing gas and the amount of exhausting gas by vacuum exhausting system 24b in equilibrium. In this state, when shutter 28f is opened, vapor flow 28e of MgO is emitted onto substrate 3. As a result, protective layer 8 of MgO film is formed on substrate 3 by vapor material which has risen to substrate 3.

When a thickness of protective layer 8 of MgO film formed on substrate 3 reaches a predetermined value (e.g. approximately 0.5 μm), shutter 28f is shut and substrate 3 is conveyed via partition 26c to substrate-unloading room 23.

The deposition space discussed above denotes a space between hearth 28b and substrate 3 in evaporation room 21, and the vacuum degree at the deposition space denotes a degree of vacuum in the space.

In this time, introducing gas for keeping the film quality of the MgO film a certain level and introducing gas for controlling the vacuum degree at the deposition space are performed by gas-introducing means 29a discussed above.

Further, for example, as the structure of deposition apparatus 20, one or more substrate-heating room for heating substrate 3 may be disposed between substrate-loading room 22 and evaporation room 21 based on a condition of a temperature profile of substrate 3. In addition, one or more substrate-cooling room may be disposed between evaporation room 21 and substrate-unloading room 23.

Still further, evaporation of MgO for substrate 3 in evaporation room 2 can be operated in a state where transporting stands still or transporting works.

Yet further, deposition apparatus 20 is not limited to the structure mentioned above, and a buffer room for controlling cycle time or a chamber room for heating/cooling may be disposed between rooms. In addition, the deposition may be performed by a batch type. These structures mentioned above have the same effects as that of the present embodiment.

According to the present invention, the example that protective layer 8 is formed of MgO by evaporation is described, however, the present invention is not limited to MgO or evaporation, and the same effects can be obtained in a case where the metal oxide film is formed.

### INDUSTRIAL APPLICABILITY

According to the present invention, a method for manufacturing a PDP, which can form a metal oxide film having high quality physical properties in a process forming the metal oxide film onto a substrate of the PDP, can be realized, so that a plasma display apparatus or the like having high display efficiency can be realized.

1. A method for manufacturing a plasma display panel (PDP) including a process for forming a metal oxide film onto a substrate of the PDP, the method comprising:
forming the metal oxide film within a range of 1×10⁻¹ Pa to 1×10⁻² Pa in a degree of vacuum in a deposition room.

2. The method for manufacturing the PDP of claim 1,
wherein the degree of vacuum is controlled by introducing oxygen gas while the deposition room is exhausted.

3. The method for manufacturing the PDP of claim 1,
wherein the degree of vacuum is controlled by introducing at least one gas selected from the group consisting of water, hydrogen, carbon monoxide and carbon dioxide while the deposition room is exhausted.

4. The method for manufacturing the PDP of claim 1,
wherein the degree of vacuum is controlled by introducing inert gas while the deposition room is exhausted.

5. The method for manufacturing the PDP of claim 1,
wherein the degree of vacuum is controlled by introducing oxygen gas and at least one of inert gas and carbon dioxide while the deposition room is exhausted.
